(19) United States
(12) Patent Application Publication
(10) Pub. No.: US 2014/0337912 A1
(43) Pub. Date: Nov. 13, 2014

(54) ELECTROSTATIC DISCHARGE PROTECTION ARRANGEMENT

(71) Applicants: William John Testin, Indianapolis, IN (US); Ronald Gene Wolenty, Fishers, IN (US)

(72) Inventors: William John Testin, Indianapolis, IN (US); Ronald Gene Wolenty, Fishers, IN (US)

(73) Assignee: Thomson Licensing, Issy de Moulineaux (FR)

(21) Appl. No.: 14/363,426

(22) PCT Filed: Dec. 9, 2011
(86) PCT No.: PCT/US11/64063

§ 371 Date: Jun. 6, 2014

(51) Int. Cl. H02H 9/04; H04N 21/4363

(52) U.S. Cl. CPC H02H 9/045; H04N 21/43635
USPC 725/151

(57) ABSTRACT

An interconnection via a High Definition Multimedia Interface (HDMI) cable between a television receiver and a set-top box, embodying an invention feature, is obtained via an HDMI cable. In HDMI specifications 1.0 through 1.3a, pin 14 of the HDMI connector was defined to be a so-called no-connect pin which would prohibit it from being connected to ground or to a power supply. An ESD protection device is coupled to unused pin 14 that, advantageously, prevented soft failure.

### FIELD OF THE INVENTION

The invention relates to an electrostatic discharge (ESD) protection arrangement.

### BACKGROUND OF THE INVENTION

FIG. 2 illustrates a conventional interconnection between a typical set-top box 100′ and a television receiver 101 via a High Definition Multimedia Interface (HDMI) cable 102. HDMI cable 102 has an HDMI connector 102a at one end thereof. When set-top box 100′ and television receiver 101 are interconnected via HDMI cable 102, detachable connector 102a mates with a corresponding HDMI connector 100a′ installed in set top box 100′. A second HDMI detachable connector 102b, at the other end of the HDMI cable 102, having a length of, for example, 5 feet, mates with an HDMI connector 101a installed in television receiver 101 for applying signals, not shown, containing video information to be displayed in a display panel, not shown, of television receiver 101.

When, a user manipulates connector 102b, for example, in the course of mating it to connector 101a of television receiver 101, a user's hand, for example, might produce an ESD to a pin of connector 102b that might produce an arc, not shown. In the absence of an ESD protection arrangement coupled to each pin of HDMI connector 102b that is connected via a conductor wire of HDMI cable 102, referred to herein as an “active wire”, to a functional electronic component, not shown in FIG. 2, of set top box 100′, the arc might cause destruction of attached electronics or a so-called soft failure in circuitry, not shown, of set top box 100′. The soft failure undesirably disrupts operation of the set top box without causing permanent damage. For example, a register bit of a microprocessor, not shown in FIG. 2, might change states due to the ESD related arc that might result in disruption of the displayed image.

One prior art solution to the ESD problem was to add an “HDMI Transmitter Port Protection” integrated circuit (IC) disposed between HDMI connector 100a′ and a microprocessor, not shown, of set top box 100′. The protection IC contains diodes to clamp selected active wires of HDMI cable 102 in addition to providing a current-limited 5V supply and level-translated control signals. However, better, less expensive, protection could be done with discrete devices and newer designs do not require the level translation.

Another prior art solution for avoiding soft failure was to couple a corresponding ESD protection device to each pin of HDMI connector 100a′ that is connected to an active wire. The ESD protection device is essentially a fast zener diode. The ESD protection device provides a low impedance to ground when the zener diode is conductive that prevents the effect of the ESD arc.

Because, intuitively, connecting a costly ESD protection device to an unused pin appears to serve no useful purpose, there appears no reason to install it on unused pins. Note that due to the high speed of the HDMI data on the differential pairs (−72 MHZ), special and costly low capacitance (<0.5 pF) ESD diodes are required. When permitted to do so, each unused pins of HDMI connector 100a′ was customarily connected to a low impedance terminal such as ground conductor or an output of a power supply. This was done, not for preventing soft failure, but for avoiding noise coupling.

In HDMI specifications 1.0 through 1.3a, pin 14 of the HDMI connector is defined to be a so-called “no-connect” pin which would prohibit it from being connected to ground or to a power supply. Beginning with HDMI specification 1.4a, pin 14 may optionally be used to implement a reverse-channel audio feature. However, if this feature is not implemented, it is still prohibited to connect pin 14 to ground or to a power supply. Therefore, pin 14 was left “floating” and the impedance between pin 14 and each element of set top box 100′ was maintained high.

In order to test the sensitivity of set top box 100′ to soft failures produced by ESD related arcs, a high voltage pulse was applied to each pin, one pin at a time, of mating connector 102b at the end of the 5 foot HDMI cable 102 and remote from set top box 100′. In connector 102b each pins is close to each adjacent pin by a distance of 0.5 mm. To obtain connection to each pin without simultaneously making inadvertent connection to any other adjacent pin, during the test, it was necessary to attach a so called “break-out” board having each output conductor separated from the adjacent one by a comfortable distance so as to avoid shorting adjacent pins of connector 102b to each other.

The test confirmed that, due to the high voltage pulse being applied to the end of the 5 ft HDMI cable, there was a sufficient inductance and series resistance associated with the wire in the cable to provide sufficient attenuation of the high voltage pulse reaching the ESD protection device. The inductance and series resistance help limit the peak current into the zener of the ESD protection device.

However, when the high voltage pulse was applied to pin 14 that is not connected to any active wire, counter intuitively, an audible arc was heard and the user lost video on the set top box until the box was reset by removing power or pressing the reset button. This is so because the high voltage pulse would charge up the capacitance of the “floating” inactive wire until an “air discharge” occurred to an adjacent pin. Although each of the adjacent pins 13 and 15 has a corresponding ESD protection device, the current is no longer limited by the inductance and resistance of the cable and due to the capacitance of the cable being able to charge up to almost the full “contact discharge voltage” of the ESD test gun before the arc to the adjacent pin occurs, the peak current in the protection zener diode on an adjacent pin undesirably exceeds the peak obtained in an active wire. Due to the lack of series impedance, the maximum permitted 3A inrush current on the ESD protection diode on the adjacent pin is exceeded so that the diode is not able to clamp the transient to the rated 12V maximum. This transient, while not enough to damage the microprocessor, could induce the soft-failures observed.

In carrying out an inventive feature, adding an ESD protection device to unused pin 14 prevented the air discharge from occurring which prevents the problem and the set top box continued to operate normally after the high voltage pulse was applied to pin 14.

### SUMMARY OF THE INVENTION

A video apparatus, embodying an inventive feature, includes a cable connector of the video apparatus adapted to mate with a corresponding cable connector attached to a cable. Circuitry is coupled to a plurality of pins of the cable connector of the set top box exclusive of a first pin. A semiconductor device is coupled to the first pin and forming, in normal operation, a high impedance to maintain the first pin electrically decoupled from any other element of the video apparatus. The semiconductor device forms low impedance at the first pin when a high voltage applied to the first pin exceeds a threshold level of the semiconductor to provide an electrostatic discharge (ESD) protection.

### BRIEF DESCRIPTION OF THE DRAWINGS

The preferred embodiment of the present invention will be described below in more detail with reference to the accompanying drawings in which:

FIG. 1 is a schematic diagram of a portion of a set top box including an ESD protection arrangement according to an inventive feature; and

FIG. 2 illustrates an inter-connection via an HDMI cable between a television receiver and the set-top box of FIG. 1, embodying an inventive feature and, alternatively, a similar inter-connection via an HDMI cable between a television receiver and a prior art set-top box.

### DETAILED DESCRIPTION

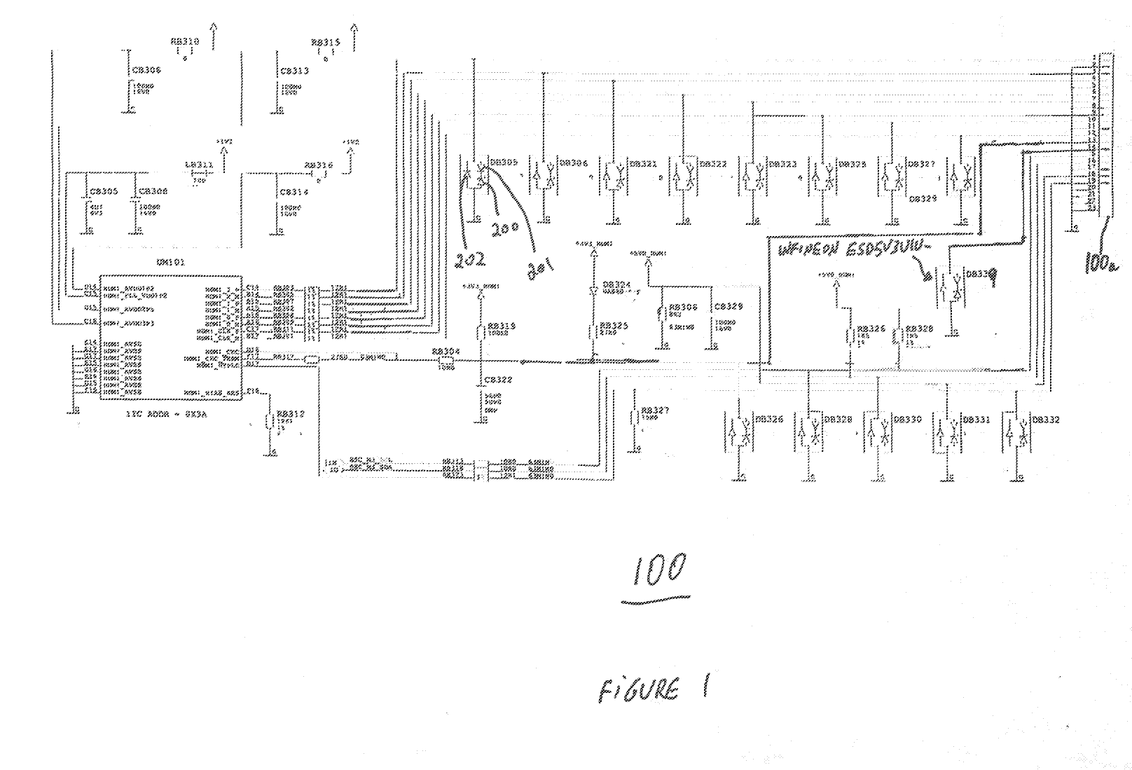

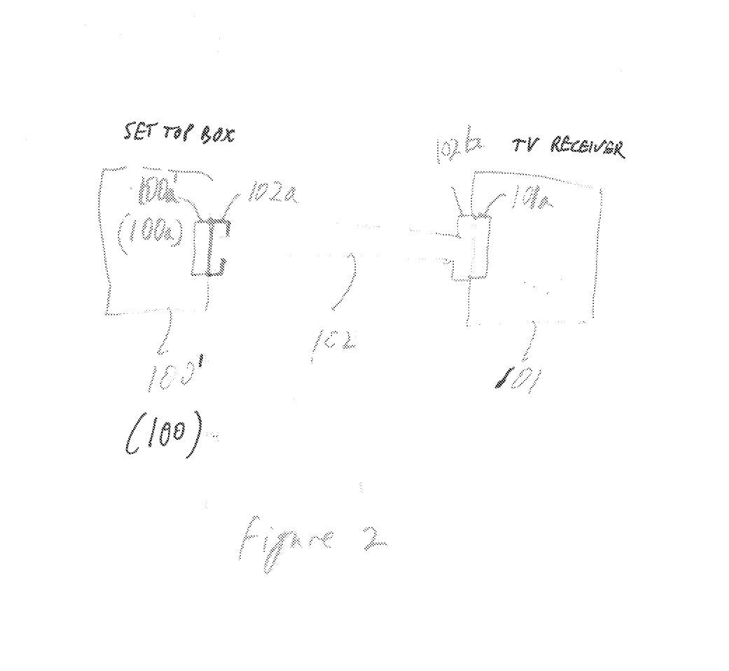

FIG. 1 illustrates schematically a set-top box 100, embodying an inventive feature. FIG. 2 illustrates the interconnection of set-top box 100 including an HDMI connector 100a, HDMI cable 102 and television receiver 101 of FIG. 2. The previously described interconnection with respect to set-top box 100′ including HDMI connector 100a′, HDMI cable 102 and television receiver 101 is equally applicable to that of set-top box 100, HDMI including connector 100a, HDMI cable 102 and television receiver 101, respectively, and will not be repeated.

In FIG. 1, connector pins 2, 5, 8, 11, 17 and 20 through 23 of HDMI connector 100a are coupled to a common ground conductor G. Except for pin 14, each of the other pins of HDMI connector 100a are coupled to circuit elements of set-top box 100 such as, for example, microprocessor UM101 and, thus, are coupled to respective active wires, not shown, of HDMI cable 102 of FIG. 2.

A pin 1, for example, of connector 100a is coupled to microprocessor UM101 and therefore to a corresponding active wire, not shown, of HDMI cable 102 of FIG. 2. In addition, a conventional ESD protection device DB305 of FIG. 1 made by Infineon Technologies AG, Munich, Germany, part No. E5D5V3U1U-, is coupled to pin 1 of connector 100a.

ESD protection device DB305 includes a zener diode 200 coupled in series with a diode 201 such that the cathodes of diodes 200 and 201 are coupled to each other and are disposed between the anodes of diodes 200 and 201. The series arrangement of diodes 200 and 201 provides a minimum threshold level of +5.3V with respect to a potential of ground conductor G. The series arrangement of diodes 200 and 201 is coupled in parallel with a diode 202 that is poled in an opposite manner with respect to diode 201 to provide a minimum threshold level of −0.6V with respect to the potential of ground conductor G. The maximum absolute value of the clamping voltage of ESD protection device DB305 is specified at a peak current of 3A not to exceed 15V. Thereby, ESD protection device DB305 forms voltage clamping, low impedance when each of its threshold levels is exceeded in a manner to prevent soft failure in, for example, microprocessor UM101. Each of ESD protection devices DB306, DB321, DB322, DB323, DB325, DB327, DB329, DB332, DB331, DB330, DB328, DB326 and DB339 has identical characteristics.

In carrying out an inventive feature, ESD protection device DB339, unlike all the other aforementioned ESD protection devices is coupled to unused pin 14 of HDMI connector 100a. In normal operation, pin 14 is decoupled from any other element of set top box 100. In normal operation, ESD protection device DB339 maintains a high impedance at pin 14. On the other hand, ESD protection device DB339 forms low impedance at pin 14 when a high voltage applied to pin 14 exceeds its threshold level of, for example, +5.3V with respect to the potential of ground conductor G, as explained before. In this way, ESD protection device DB339 provides ESD protection. ESD protection device DB339 on pin 14 need not be of the same low capacitance type used in the other ESD protection devices. However, it should preferably have a maximum clamping voltage of 15V.

1. A set top box, comprising:
a High Definition Multimedia Interface (HDMI) cable connector of said set top box adapted to mate with a corresponding first HDMI cable connector attached to an HDMI cable;
circuitry coupled to a plurality of pins of said HDMI cable connector of said set top box exclusive of a first pin; and
a semiconductor device coupled to said first pin and forming, in normal operation, a high impedance to maintain said first pin electrically decoupled from any other element of said set top box, said semiconductor device forming a low impedance at said first pin when a high voltage applied to said first pin exceeds a threshold level of said semiconductor to provide an electrostatic discharge (ESD) protection.

2. A set top box according to claim 1 wherein said semiconductor comprises a zener diode and wherein said threshold level is determined by a breakdown voltage of said zener diode.

3. A set top box according to claim 1 wherein a corresponding semiconductor device is coupled to each of said plurality of pins of said HDMI cable connector of said set top box for providing an electrostatic discharge (ESD) protection.
